(19) United States
(12) Patent Application Publication
(10) Pub. No.: US 2015/0201822 A1
(43) Pub. Date: Jul. 23, 2015

(54) WIPE PAD FOR MOP HEADS

(71) Applicant: Habib Rostami, Irvine, CA (US)

(72) Inventor: Habib Rostami, Irvine, CA (US)

(21) Appl. No.: 14/160,295

(22) Filed: Jan. 21, 2014

(51) Int. Cl. A47L 13/24; B29C 65/08

(52) U.S. Cl. CPC A47L 13/24; B29C 65/08; B29L 2031/7406

(57) ABSTRACT

A wet wipe pad designed to be connected or attached to floor mop heads that utilize a hook-and-loop mechanism for attaching the wipe pad to the mop head. The wipe pad includes a cleaning layer ultrasonically welded to an attachment layer having an absorption layer disposed between the cleaning layer and the attachment layer. The wipe pad is configured with at least one linking ribbon or strip of fibers forming ‘loops’ extending along the length of the attachment layer for being releasably secured to ‘hooks’ disposed on the mop head.

### CROSS-REFERENCE TO RELATED APPLICATION

This application claims the benefit of U.S. Provisional Application Ser. No. 61/754,767, filed Jan. 21, 2013, the content of which is hereby incorporated herein by reference.

### BACKGROUND OF THE INVENTION

The present invention relates to the field of cleaning devices. This invention generally relates to replaceable wipe pads for use with floor cleaning mop heads in wet applications, and specifically to wet wipe pads that attach to mop heads that utilize a ‘hook-and-loop’ mechanism for attaching the wipe pad to the mop head.

As shown in FIGS. 1 and 2, various floor cleaning mops currently exist that have a mop head 100 that incorporates a hook-and-loop fastening mechanism (for example, as manufactured under the brand name VELCRO by Velcro USA, Inc. of Manchester, N.H.) embodied in one or more lineal (linear) strips 122, 124 or other attachment configurations (for example, round “dots” or squares) for allowing removable wipe pads 200 to be attached from a first end 130 to a second end 140 along the body 110 of the mop head having a handle portion 150. Such wipe pads may include a suitable surface 210 for to retaining one or more hook-and-loop (touch fastener) strips 222, 224 extending from a first end 330 to a second end 340 along the surface of the wipe pad for attachment onto the mop head. As the wipe pad is used and becomes dirty, the wipe pad can be removed, thrown away (discarded), and then replaced with a new, clean wipe pad.

In such existing designs, the physical construction of the removable wipe pad 200 is such that multiple layers of the surface material 210, typically made of polyester (or P.E.), are sewn or glued together to assemble the wipe pad. However, although these existing wipe pads may be able to attach to the mop head 10 via the hook-and-loop mechanisms in a dry environment. One of the drawbacks or shortcomings of the known design is that the wipe pad strips 222, 224 having the ‘loops’ do not able to attach well (or satisfactorily remain attached) to the mop head strips 122, 124 having the ‘hooks’ in situations when the mop is used to clean wet floors and the wipe pad gets wet. As such, when existing wipe pads are used to clean wet floor or in other wet application, either the strips on the wipe pad do not attach well to the strips on the mop head, or the strips on the wipe pad become detached and fall off the mop head.

Another known cleaning device has a cleaning pad support platen defining a support cleaning surface region that is arranged to releasably receive and secure a conventional cleaning pad using hook-and-loop fasteners on the platen. The cleaning pad includes a relatively non-abrasive cleaning surface. A scrub device with a relatively more abrasive surface is attached to the cleaning pad. One or more such scrub devices may be attached to the same cleaning pad surface to cover part or all of the cleaning pad surface. The abrasive scrub devices may have different dimensions to cover different areas of the cleaning pad non-abrasive surface to provide enhanced scrubbing action as desired. The abrasive scrub devices may be provided with different abrasion surfaces having different abrasive values and may be removed to expose the full non-abrasive cleaning surface for non-abrasive cleaning. Also known are hand held devices having multiple layer scrubbing pads for attaching to a rigid hand held handle. Such devices are unduly expensive and difficult to manufacture as a disposable wipe pad.

In view of the foregoing, there is a need for, and what was heretofore unavailable, are replaceable wipe pads for use with floor cleaning mop heads that attach to mop heads using a ‘hook-and-loop’ mechanism without sewing or gluing such that the wipe pad remains attached to the mop head in wet conditions. There is a further need for mop head wipe pads that are economically manufactured, simple to use and can easily and removably attach itself, to the mop head, wherein the wipe pad has good liquid absorbency and is able to be used in wet mopping applications without the wipe pad falling off the mop head or coming loose from the mop head. The present invention fulfills these and other needs.

### SUMMARY OF THE INVENTION

Briefly, and in general terms, the present invention is directed to replaceable wipe pads for use with floor cleaning mop heads in wet applications that utilize a ‘hook-and-loop’ mechanism for attaching the wipe pad to the mop head. The wet wipe pad of the present invention is designed to be connected or attached to floor mop heads that utilize a hook-and-loop mechanism for attaching the wipe pad to the mop head, such as the existing mop head shown in FIG. 1.

The composition of materials used in manufacturing the wipe pad of the present invention is designed to absorb and hold liquid (for example, water) while performing the function of cleaning or mopping of floors and other surfaces. The physical construction of the wipe pad is designed to use no glue or sewing for assembling of the pad. Rather, the wipe pad of the present invention may be assembled and manufactured using ultrasound and embossing and pressing equipment that are known to those skilled in the art of designing such cleaning devices and similar multi-layered products. In addition, the wipe pad may include multiple logo-embossed areas formed by ultrasound pressing to provide for additional connectivity of the various layers of the wipe pad together.

The wipe pad of the present invention includes a first substantially rectangular cleaning pad (layer), a second substantially rectangular attachment pad (layer), and a third substantially rectangular absorption pad (layer) disposed between the first pad and the second pad. The attachment pad is configured with a first and second strip of fibers (linking ribbon) extending from the first end to the second end of the attachment pad. The cleaning pad is attached to the attachment pad by ultrasound. The first strip of fibers and the second strip of fibers are attached to the attachment pad by ultrasound such that several attachment segments are formed within both strips of fibers. The cleaning pad is formed from polyester and viscose, the attachment pad is formed from polypropylene, and the third pad is formed from wood pulp or viscose (or other suitable absorption material). Each of the first pad, the second pad and the third pad may include at least one embossed portion

The present invention further contemplates a method for manufacturing a wipe pad. The manufacturing process includes forming a first rectangular cleaning pad from polyester and viscose, forming a second substantially rectangular attachment pad from polypropylene, and forming a third substantially rectangular absorption pad from wood pulp or viscose (or other suitable liquid absorption material). The absorption pad is positioned between the cleaning pad and the attachment pad, and known ultrasound manufacturing techniques are used to attach the cleaning pad to the attachment pad. Similarly, a first linking ribbon and second linking ribbon are attached to the second pad using ultrasound. The linking ribbons may be formed with a wave pattern using ultrasound manufacturing processes known to one of ordinary skill in the art.

Other features and advantages of the invention will become apparent from the following detailed description, taken in conjunction with the accompanying drawings, which illustrate, by way of example, the features of the invention.

### BRIEF DESCRIPTION OF THE DRAWINGS

FIG. 1 is a bottom plan view of a prior art mop head.

FIG. 2 is a top plan view of a prior art wipe pad.

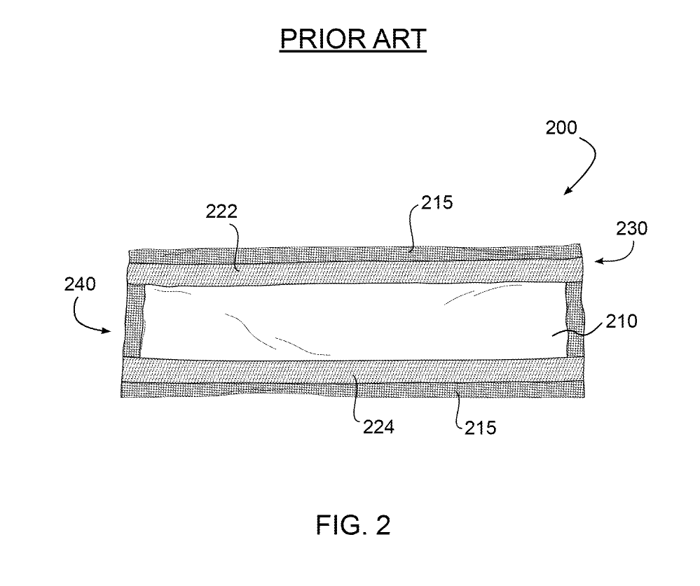

FIG. 3 is a front plan view of a cleaning layer of an embodiment a wipe pad of the present invention.

FIG. 4 is front plan perspective view of an attachment layer of an embodiment a wipe pad of the present invention.

FIG. 5 is a side plan view of an embodiment a wipe pad of the present invention taken along line 5-5 of FIG. 4.

FIG. 6 is a front perspective view of an embodiment a wipe pad in accordance with the present invention.

FIG. 7 is a front plan view of an alternative embodiment a cleaning layer of a wipe pad in accordance with the present invention.

FIG. 8 is a front plan view of an alternative embodiment an attachment layer of a wipe pad in accordance with the present invention.

FIG. 9 is a front plan view of a wipe pad of the present invention wherein a cleaning layer is partially pulled away from an attachment layer to expose an absorption layer.

### DETAILED DESCRIPTION OF THE INVENTION

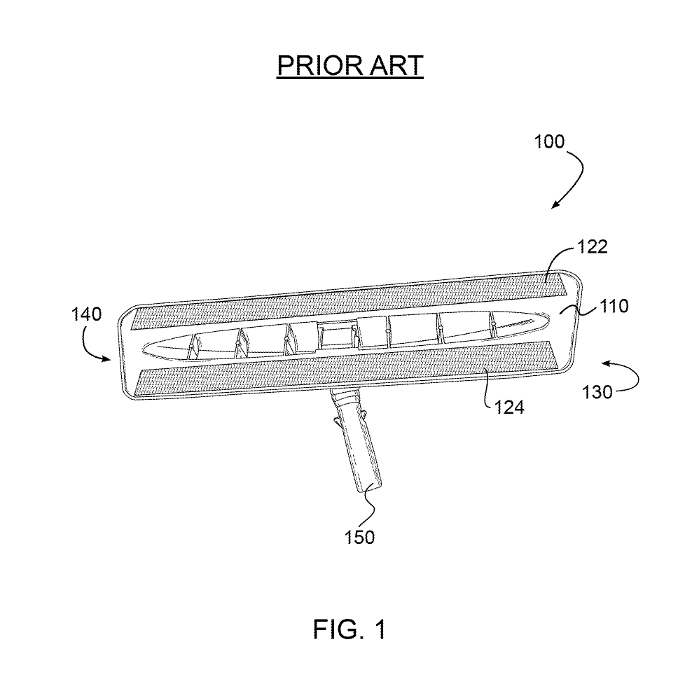

As shown in the drawings for purposes of illustration, the present invention is directed to a cleaning device. The wet wipe pad of the present invention is designed to be connected or attached to floor mop heads that utilize a hook-and-loop mechanism for attaching the wipe pad to the mop head, such as the existing mop head shown in FIG. 1. The wipe pad includes a cleaning layer (sheet or pad) ultrasonically welded to an attachment layer (sheet or pad) having an absorption layer (sheet or pad) disposed between the cleaning layer and the attachment layer. The attachment layer is configured with at least one linking ribbon or strip of fibers extending along the length of the layer for being releasably secured to ‘hooks’ disposed on the mop head.

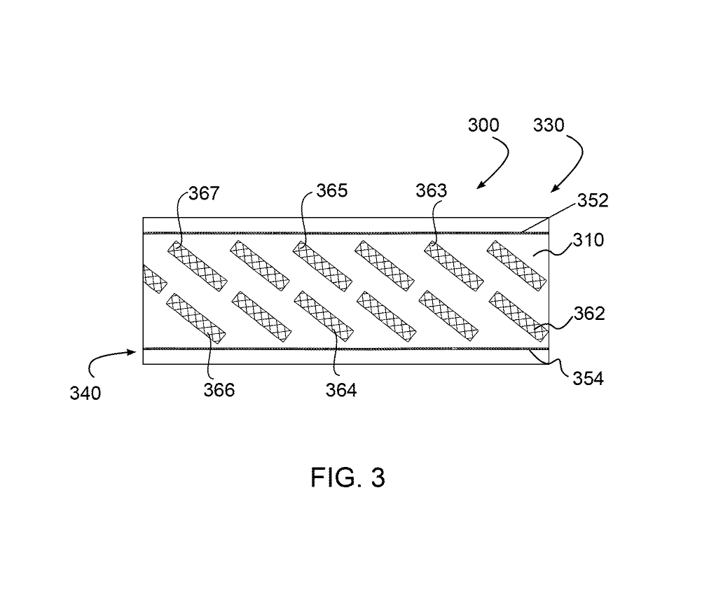

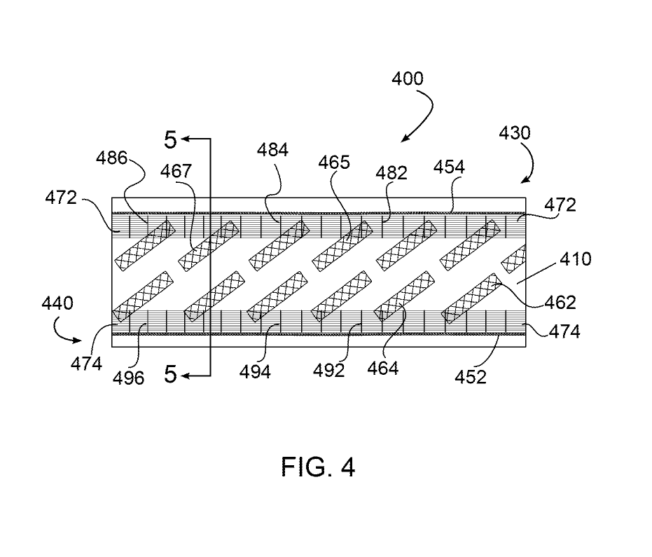

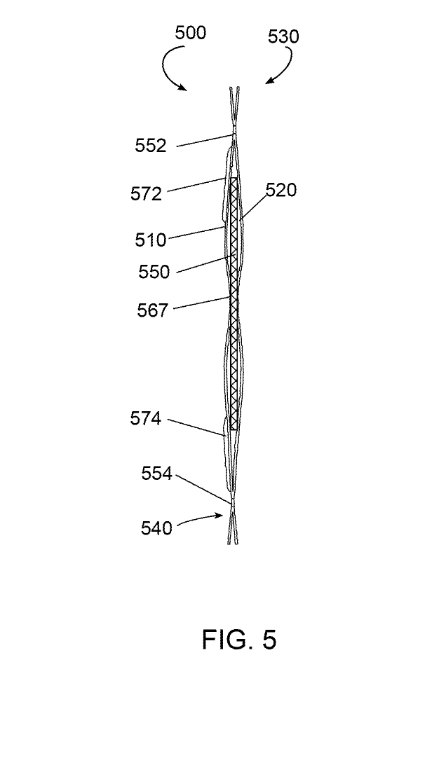

Turning now to the drawings, in which like reference numerals represent like or corresponding aspects of the drawings, and with particular reference to FIGS. 3 to 5, the wipe pad of the present invention includes a cleaning surface 310 (FIG. 3), an attachment surface 410 (FIG. 4) and an absorption portion 550 (FIG. 5) disposed between the two surfaces. As shown in FIG. 3, and by way of example, the cleaning pad 300 includes a cleaning surface 310 extending from a first (right) end 330 to a second (left) end 340 of the pad. The cleaning pad is shown with a first (top) ultrasound (pressed) junction 352 and a second (bottom) ultrasound junction 354 resulting from the process of securing the cleaning pad to the attachment pad (see FIG. 5). The ultrasound pressed junctions may be linear or other shapes adequate for securing the two layers. Furthermore, the junctions need not be contiguous; however, a continuous linear weld adds strength and rigidity to the assembled wipe pad.

As also shown in FIG. 3, the surface 310 of the cleaning pad 300 may include multiple embossed areas 362, 363, 364, 365, 366 (shown in diagonally placed positions) formed by ultrasound pressing to provide for additional connectivity of the various layers of the wipe pad together. The embossed portions may include a logo, text or other symbols for product identification such as a trademark, brand name or company name. The embossed areas may provide additional strength and rigidity to the assembled wipe pad.

The cleaning layer 300, 520 of the wipe pad 500 may be formed from a combination of materials that enables the wipe pad to act as a wet wipe and absorb liquid when the wipe pad touches a floor or other surface to be cleaned. The material of the cleaning layer is selected to enable the cleaning layer to attach to other layers of the wipe pad with ultrasound equipment. In one embodiment, the cleaning pad material includes an absorption material such as viscose (for example, fifteen to twenty-five percent and preferably twenty percent by weight) and a non-woven polyester (for example, seventy to ninety percent and preferably eighty percent) with a weight in the range of fifty to seventy grams-per-square-meter (GSM) and preferably sixty GSM. Alternative and suitable materials for absorption in the cleaning pad include products that provide adequate absorption of liquids while achieving the objectives of the present invention to provide economical, relatively lightweight and easy to manufacture wipe pads. Alternative materials for non-woven polyester include products that are compatible with the absorption material, are economical and are responsive to an ultrasound manufacturing process.

Referring now to FIG. 4, and by way of example, the attachment pad 400 includes a middle surface 410 extending from a first (right) end 430 to a second (left) end 440 of the pad. The attachment pad is shown with a first (top) ultrasound (pressed) junction 452 and a second (bottom) ultrasound junction 454 resulting from the process of securing the cleaning pad 300 to the attachment pad (see FIG. 5). The surface of the attachment pad may include multiple embossed areas 462, 464, 465, 464 (shown in diagonally placed positions corresponding to those shown in FIG. 3) formed by ultrasound pressing. The material of the attachment layer 400 is selected to enable the attachment layer to bond to other layers of the wipe pad with ultrasound equipment. In one embodiment, the attachment pad material is formed from non-woven polypropylene with a weight in the range of thirty to forty GSM and preferably thirty-five GSM. Alternative materials to form the attachment pad include products that are economical and are responsive to an ultrasound manufacturing process.

With further reference to FIG. 4, at least one linking ribbon (tape) 472, 474 is secured to the attachment layer 400 of the wipe pad 500. As shown, a pair of linking ribbons is configured along the longitudinal edges (upper and lower) so as to allow the wipe pad to be attached to the ‘hook’ mechanism that is part of existing mop heads (FIG. 1). Each linking ribbon 2 is made of polypropylene material and its surface is configured with segmented loops for connection with the hooks that are typically provided on the attachment strip(s) positioned on the mop head.

In distinction from other existing wipe pads, the linking ribbon of the present invention does not connect to the body of the wipe pad by glue or sewing/stitching, and instead it is secured to the body of the pad by use of ultrasound technique and equipment. Moreover, each linking ribbon is made of very thin and fine threads so as to create the most and best effective connection with the strip of attachment ‘hooks’ on the mop head. The wave-like pattern is formed using multiple ultrasound pressed area lines 482, 484, 486, 492, 494, 496 in the linking ribbon. In this unique manner of construction and assembly, when the linking ribbon and wipe pad of the present invention come into contact with liquid (for example, water) and become wet, the connection between the segmented linking tape on the wipe pad and the strip of attachment ‘hooks’ on the mop head holds well such that the wipe pad does not come apart from the mop head unexpectedly. Therefore, unlike existing wipe pads, the design and construction of the present invention allows the wipe pad to remain securely attached to the mop head in wet applications.

As shown in FIG. 5, the assembled wipe pad 500 of the present invention includes a pair of ultrasound pressed lines 552, 554 along the two longitudinal edges 530, 540 of the pad for connecting the cleaning layer 520 to the attachment layer 510. There are at least one ultrasound pressed (embossed) area 567 positioned at intervals along the length of the wipe pad. Two linking tape/ribbons 572, 574 are shown in cross section proximate the edges of the attachment layer. An absorption layer (pad, sheet) 550 is disposed between the cleaning layer and the attachment layer. The absorption pad may be formed from a material such as wood pulp or viscose so as to hold cleaning liquid formulas, having a weight in the range of one hundred to two hundred and preferably one hundred-fifty GSM. Alternative materials suitable for the absorption pad include products that provide adequate absorption of liquids while achieving the objectives of the present invention to provide economical, relatively lightweight and easy to manufacture wipe pads.

In an embodiment of the present invention and by way of example only, the wipe pad weighs fourteen grams. In such an example, the pad is thirteen centimeters (cm) wide by forty cm long (approximately five inches by sixteen inches). The thickness of that wipe pad is 1.5 millimeters (mm), and the linking ribbon is two cm wide. In accordance with the present invention, however, the wipe pad may be made in various sizes, shapes to accommodate a particular mop head and its intended use.

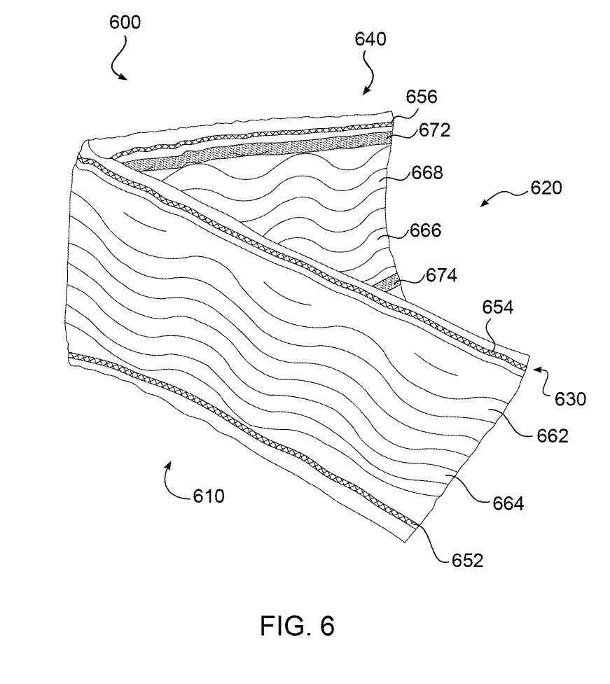

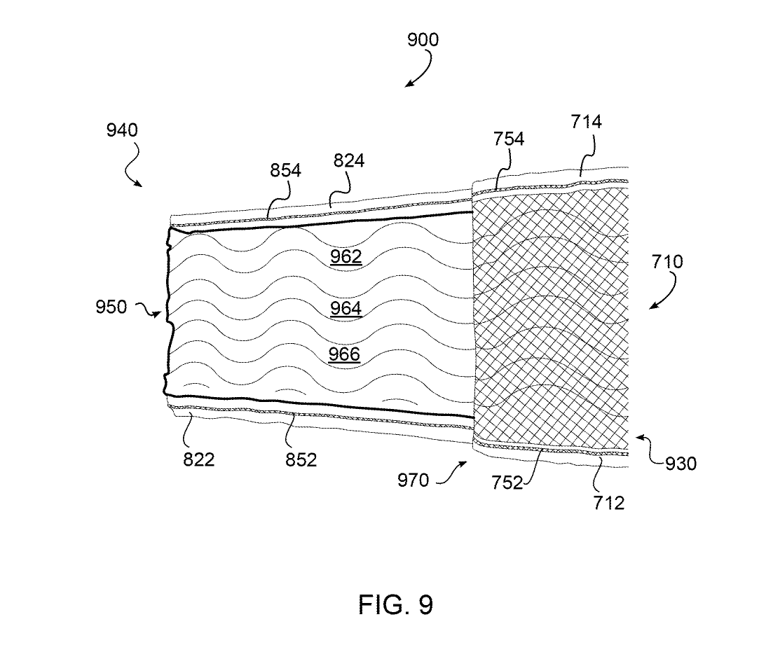

Referring now to FIG. 6, the multi-ply wipe pad of the present invention has a structural rigidity to stand on its edges when folded or bent. This alternative embodiment of the wipe pad 600 is similar to that depicted in FIGS. 3-5, but is shown in perspective for clarity of understanding the relationship of the portions of the invention. For example, the assembled wipe pad includes a pair of ultrasound pressed lines 652, 654 along the two longitudinal edges of the cleaning pad 610. Also shown is the first ultrasound pressed line 656 on the attachment layer 620 that extends from the first (right) end 630 to the second (left) end of the wipe pad 640 and corresponds to the second (upper) ultrasound pressed line 654 on the cleaning pad. The attachment pad is shown with two linking strips 672 and 674 for releasably connecting to the ‘hook’ portions of a mop head (FIG. 1). In this embodiment, multiple embossed areas 662, 664, 666 and 668 are curved and are pressed through both the cleaning pad and the attachment pad to provide structural integrity with the adapter assembly pad (FIG. 9).

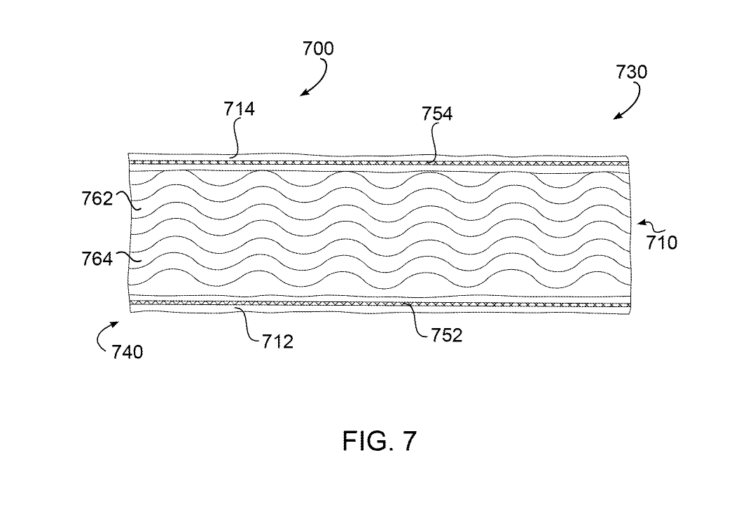

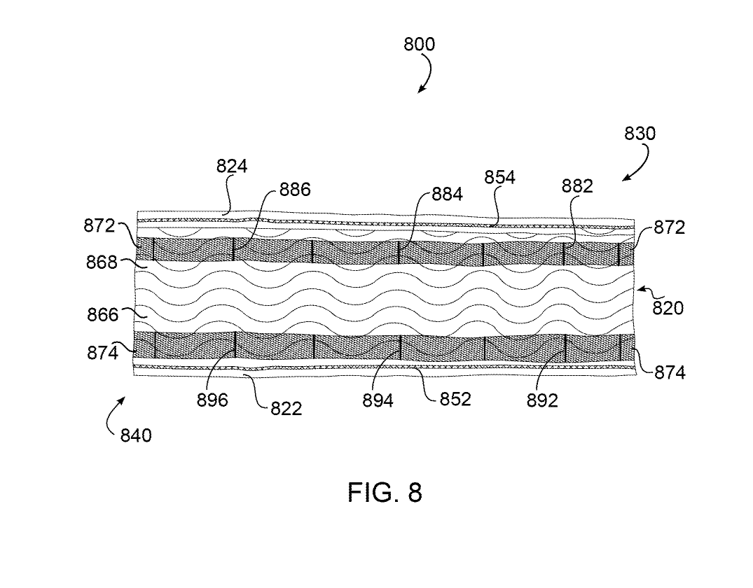

As shown in FIGS. 7, 8 and 9, an alternative embodiment of the wipe pad 900 of the present invention includes a cleaning layer 700 (FIG. 7) ultrasonically welded to an attachment layer 800 (FIG. 8) having an absorption layer 950 (FIG. 9) disposed between the cleaning layer and the attachment layer. The assembled wipe pad includes a first (lower) ultrasound pressed line 752, 852 along the lower longitudinal edge 712 of the cleaning pad and the lower edge 822 of the attachment layer. The assembled wipe pad further includes a second (upper) ultrasound pressed line 754, 854 along the upper longitudinal edge 714 of the cleaning pad and the upper edge 824 of the attachment layer. The ultrasound pressed lines on the cleaning layer extend from the first (right) end 730, 830, 930 to the second (left) end 740, 840, 940 of the wipe pad and correspond to the second (upper) ultrasound pressed line 654 on the cleaning pad.

The attachment layer 800 is configured with at least one strip of linking fibers (threads) 872, 874 extending along the longitudinal length of the layer (see FIG. 8). The strips of fibers may be formed from polypropylene or other suitable material, wherein a ribbon (tape) may be disposed on a roll (spool) such that the fibers are positioned along the longitudinal length of the attachment pad. The linking fibers are secured to the attachment pad and segmented by ultrasound formed vertical (perpendicular to the longitudinal length) lines 882, 884,886, 892, 894, 896 in the two sets of linking strips, thereby forming ‘waves’ in the fibers. The ultrasound areas in the linking strip secure the fibers to the middle portion 820 of the attachment layer. The linking fiber strips on the attachment layer extend from the first (right) end 730, 830, 930 to the second (left) end 740, 840, 940 of the wipe pad and are proximate the lower edge 822 and the upper edge 824. The segmented strips of fiber securely (but releasably) fasten to the portions of a mop head having ‘hook’ strips or otherwise formed segment (see FIG. 1).

The wipe pad 900 is shown with an absorption pad 950 disposed between the cleaning layer 700 and the attachment layer 800 (see FIG. 9). In this embodiment, multiple embossed areas are curved and are pressed through each of the cleaning layer 762, 764; absorption pad 962, 964, 966; and the attachment layer 866, 868 to provide structural integrity within the wipe pad. The embossed portions may include a logo, text or other symbols for product identification such as a trademark, brand name or company name.

Those skilled in the art of manufacturing mechanical devices such as the disclosed cleaning device can determine, without undue experimentation, the appropriate dimensions, geometries, materials, and other features of the wipe pad. Other embodiments in accordance with the present invention (for example, but not limited to, use with various mop heads or a hand-held apparatus) may be employed as is known to those skilled in the art of designing and/or manufacturing of cleaning devices. Similarly, those skilled in the art will understand from the disclosure herein that various modifications to the components (cleaning layer, attachment layer, absorption pad and linking ribbon or fibers) of the wipe pad can be made without departing from the scope of the invention. More specifically, the present invention is not limited to any particular method of forming (manufacturing) the wipe pad and it components.

While certain aspects of the invention have been illustrated and described herein in terms of its use as a wipe pad for use with a mop head, modifications and improvements to the disclosed apparatus may be made without departing from the scope of the invention. Accordingly, the scope of the invention is not intended to be limited by, for example, but not limited to, the details of the drawings and the appended claims.

I claim:

1. An apparatus, comprising:
a first substantially rectangular pad having a first end, a second end and a middle portion formed between the first end and the second end;
a second substantially rectangular pad having a first end, a second end and a middle portion formed between the first end and the second end,
wherein the middle portion of the second pad is configured with a first strip of fibers extending from the first end to the second end, and
wherein the middle portion of the second pad second pad is configured with a second strip of fibers extending from the first end to the second end; and
a third substantially rectangular pad disposed between the first pad and the second pad.

2. The apparatus of claim 1, wherein the first pad is attached to the second pad by ultrasound.

3. The apparatus of claim 1, wherein the first strip of fibers and the second strip of fibers are attached to the second pad by ultrasound.

4. The apparatus of claim 1, wherein both the first strip of fibers and the second strip of fibers are attached to the second pad using ultrasound such that a plurality of attachment segments are formed within both the first strip of fibers and the second strip of fibers.

5. The apparatus of claim 4, wherein the first strip of fibers and the second strip of fibers are formed from a material consisting essentially of polypropylene.

6. The apparatus of claim 1, wherein the first pad is formed from a material consisting essentially of polyester and viscose, the second pad is formed a material consisting essentially of polypropylene and the third pad is formed from a material consisting essentially of wood pulp or viscose.

7. The apparatus of claim 6, wherein the first pad is formed from eighty percent non-woven polyester and twenty percent viscose, having a weight of sixty grams-per-square-meter.

8. The apparatus of claim 6, wherein the second pad has a weight of thirty-five grams-per square-meter.

9. The apparatus of claim 6, wherein the third pad has a weight of one hundred-fifty grams-per square-meter.

10. The apparatus of claim 1, wherein the first pad, the second pad and the third pad each include at least one embossed portion.

11. An apparatus, comprising:
a first substantially rectangular layer having a first end, a second end and a middle portion formed between the first end and the second end, wherein the first layer has a first longitudinal edge and a second longitudinal edge;
a second substantially rectangular layer having a first end, a second end and a middle portion formed between the first end and the second end, wherein the second layer has a first length edge and a second longitudinal edge,
wherein the middle portion of the second layer is configured with a first linking ribbon extending from the first end to the second end and being positioned proximate the first longitudinal edge of the second layer, and
wherein the middle portion of the second layer is configured with a second linking ribbon extending from the first end to the second end and being positioned proximate the second longitudinal edge of the second layer; and
a third substantially rectangular layer disposed between the first layer and the second layer,
wherein the first longitudinal edge of the first layer is attached to the first longitudinal edge of the second layer using ultrasound,
wherein the second longitudinal edge of the first layer is attached to the second longitudinal edge of the second layer using ultrasound, and
wherein both the first linking ribbon and the second linking ribbon are attached to the second layer using ultrasound.

12. The apparatus of claim 11, wherein both the first linking ribbon and the second linking ribbon are attached to the second layer using ultrasound such that a plurality of attachment segments are formed within both the first linking ribbon and the second linking ribbon.

13. The apparatus of claim 11, wherein the first layer is formed from a material consisting essentially of polyester and viscose, wherein the second layer is formed from a material consisting essentially of polypropylene, wherein the third layer is formed from a material consisting essentially of wood pulp or viscose, and wherein both the linking ribbon and the second linking ribbon are formed from a material consisting essentially of polypropylene.

14. The apparatus of claim 13, wherein
the first layer is formed from eighty percent non-woven polyester and twenty percent viscose, having a weight of sixty grams-per-square-meter,
the second layer has a weight of thirty-five grams-per square-meter, and
the third layer has a weight of one hundred-fifty grams-per square-meter.

15. A process for manufacturing a wipe pad, comprising:
forming a first substantially rectangular pad from a material consisting essentially of polyester and viscose such that the first pad has a first end, a second end and a middle portion formed between the first end and the second end, wherein the first pad further has a first longitudinal edge and a second longitudinal edge;
forming a second substantially rectangular pad from a material consisting essentially of polypropylene such that the second pad has a first end, a second end and a middle portion formed between the first end and the second end, wherein the second pad has a first longitudinal edge and a second longitudinal edge,
forming a third substantially rectangular pad from a material consisting essentially of wood pulp or viscose;
using ultrasound to attach a first strip of fibers extending from the first end to the second end of the middle portion of the second pad and being positioned proximate the first longitudinal edge of the second pad;
using ultrasound to attach a second strip of fibers extending from the first end to the second end of the middle portion of the first pad and being positioned proximate the second longitudinal edge;
placing the third pad between the first pad and the second pad;
using ultrasound to attach the first longitudinal edge of the first pad to the first longitudinal edge of the second pad; and
using ultrasound to attach the second longitudinal edge of the first pad to the second longitudinal edge of the second pad.
